(19) United States
(12) Patent Application Publication
(10) Pub. No.: US 2025/0037176 A1
(43) Pub. Date: Jan. 30, 2025

(54) METHOD AND SYSTEM FOR SECURE PAYMENT TRANSACTIONS USING DIRECT PROCESSOR COMMUNICATION

(71) Applicant: Atishay Jain, REDMOND, WA (US)

(72) Inventor: Atishay Jain, REDMOND, WA (US)

(21) Appl. No.: 18/911,283

(22) Filed: Oct. 10, 2024

Related U.S. Application Data
(60) Provisional application No. 63/679,625, filed on Aug. 6, 2024.

(51) Int. Cl. G06Q 30/04; G06Q 20/32; G06Q 20/36

(52) U.S. Cl. CPC G06Q 30/04; G06Q 20/3276; G06Q 20/3278; G06Q 20/36

(57) ABSTRACT

A method and system for secure payment transactions using direct processor communication is provided. The method includes creating a payment invoice by the merchant using a payment facilitating application provided by a payment provider. Further, the method includes sending the payment invoice to a consumer in real-time by either scanning a payment invoice code or tapping a consumer's communication device to transfer the invoice data. Further, the method includes processing payment by the consumer using a payment application or manually entering card details on the consumer's device, without transmitting secret card details to the merchant. Furthermore, the method includes updating the merchant payment invoice automatically upon completion of the payment transaction.

### CROSS-REFERENCE TO RELATED PATENT DOCUMENTS

This patent application claims the benefit of priority of U.S. Provisional Application No. 63/679,625, entitled “METHOD AND SYSTEM FOR SECURE PAYMENT TRANSACTIONS USING DIRECT PROCESSOR COMMUNICATION,” filed Aug. 6, 2024, which is hereby incorporated herein by reference in its entirety.

### TECHNICAL FIELD

The present invention relates generally to secure payment processing systems and methods, and more particularly, to a method for conducting payment transactions at merchant sites in a manner that ensures the confidentiality of the consumer's card details. The method leverages advanced payment technologies such as QR codes, NFC, and mobile payment applications to facilitate secure and efficient payment processing without exposing sensitive card information to the merchant.

### BACKGROUND

The rapid advancement of digital payment technologies has transformed the way consumers and merchants conduct transactions. Despite these advancements, traditional methods of payment processing, which involve sharing sensitive card information, still pose significant security risks. Credit and debit card fraud has become a pervasive issue, leading to substantial financial losses for both consumers and businesses.

In traditional payment systems, the consumer's card details, including the card number, expiration date, and CVV, are transmitted to the merchant, who then forward these details to the payment processor for authorization. This flow of sensitive information creates multiple points of vulnerability where data can be intercepted or misused. The need for more secure payment methods has driven the development of technologies such as tokenization, which aims to protect cardholder data by replacing sensitive card details with unique, randomly generated tokens.

Tokenization enhances the security of online and in-store payments by ensuring that actual card details are not shared with merchants. Instead, tokens are used to represent card information during transactions. These tokens are meaningless if intercepted and can only be used in the context of a specific transaction with a designated merchant. This significantly reduces the risk of data breaches and fraud. Despite the benefits of tokenization, the process of integrating it into existing payment systems can be complex. Merchants must adopt new technologies and ensure compatibility with various payment processors. Additionally, consumers must be educated on the use of tokens and the security advantages they offer.

One significant issue that has emerged is the cloning of credit cards, even those equipped with EMV chips, which were initially designed to enhance security. Fraudsters have developed methods to bypass these security measures, such as EMV bypass cloning, where the communication between the chip and the point-of-sale terminal is intercepted, allowing the creation of a cloned card. To address these vulnerabilities, digital payment technologies such as Google Pay and PhonePe have been introduced. However, even these advanced systems are not without flaws. These payment technologies often rely on merchant devices to collect card or account details from customers. This dependency on merchant devices introduces another layer of vulnerability, as these devices can be compromised, leading to potential data breaches. The security of mobile payment applications depends significantly on the integrity of the merchant's infrastructure, which may not always be foolproof.

U.S. Pat. Publication No. 20140279469 discloses a method and system for mobile transaction payments are described wherein a merchant device generates a machine-readable code with transaction details and merchant information. This code is displayed to a user device, which scans it or receives the information via NFC. The user device then communicates the transaction and secure account information, such as a virtual credit card, to a merchant acquiring host. This host processes the payment in conjunction with an issuer host. Upon receiving authorization from the issuer host, the merchant acquiring host updates both the merchant and the user on the transaction status. One significant drawback of this system is the potential security vulnerability associated with the merchant device handling transaction and account details. If the merchant device is compromised, it could lead to unauthorized access to sensitive information. Additionally, the reliance on the merchant device for facilitating the transaction process also increases the chances of data breach.

In response to these evolving trends and challenges, there is an increasing demand for a sophisticated payment transaction system that can conduct payment transactions and minimize the exposure of sensitive card details. The system ensures that merchants do not collect or store any card or account information directly from the customer.

Although various methods and systems for providing secure transactions have been proposed in the past, they have their shortcomings or limitations, thus there still exists a need for a system and method for improving the security and efficiency of electronic transactions. Additionally, traditional systems sometimes fail to fully protect against emerging security threats or provide adequate user privacy. Therefore, it is essential to develop innovative approaches that address these limitations by offering more streamlined, user-friendly, and robust solutions for secure transactions, ensuring both data protection and ease of use in an increasingly digital world.

### SUMMARY

It will be understood that this disclosure is not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only and is not intended to limit the scope of the present disclosure.

In an embodiment, the present invention facilitates a payment transaction at a merchant site without sharing secret card details with the merchant. The method includes creating a payment invoice by the merchant using a payment facilitating application provided by a payment provider. Further, the method includes sending the payment invoice to a consumer in real-time by either scanning a payment invoice code or tapping a consumer's communication device to transfer the invoice data. Further, the method includes processing payment by the consumer using a payment application or manually entering card details on the consumer's device, without transmitting secret card details to the merchant. Further, the method includes updating the merchant payment invoice automatically upon completion of the payment transaction.

In an embodiment, the payment invoice is sent to the consumer via a QR code that can be scanned using the consumer's communication device. In another embodiment, the payment invoice is sent to the consumer through a URL link transmitted by NFC tapping.

In an embodiment, the consumer uses a digital wallet application, such as Google Pay or Apple Pay, to process the payment.

In an embodiment, the consumer manually enters the card information on their communication devices to complete the payment transaction.

In an embodiment, the method further comprises the step of the merchant software automatically updating the payment status of the invoice upon receipt of payment confirmation from a payment processor.

In an embodiment, the consumer receives a digital receipt on their communication devices after the payment is completed.

In an embodiment, the digital receipt is automatically integrated with a consumer's invoice management application.

These and other features and advantages of the present invention will become apparent from the detailed description below, in light of the accompanying drawings.

### BRIEF DESCRIPTION OF THE DRAWINGS

FIG. 1 illustrates a general implementation of a method and system for secure payment transactions using direct processor communication, according to an exemplary embodiment of the present invention;

FIG. 2 illustrates a schematic diagram of various sub-modules of the system for secure payment transactions, according to an embodiment of the present invention;

FIG. 3 is a sequence diagram illustrating communication between different devices for secure payment transactions, according to an embodiment of the present invention;

FIG. 4 is an example snapshot illustrating a payment invoice link received by a consumer, according to an embodiment of the present invention;

FIG. 5 is an example snapshot illustrating an updated payment invoice received by a consumer, according to an embodiment of the present invention;

FIG. 6 illustrates a flow diagram of a method for secure payment transactions using direct processor communication, according to an embodiment of the present invention; and

FIG. 7 illustrates a computing environment of a consumer electronic device conducting a payment transaction at a merchant site without sharing secret card details with a merchant, according to an embodiment of the present invention.

### DETAILED DESCRIPTION

As used in the specification, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. There may be additional components or processes described in the foregoing application that are not depicted on the described drawings. In the event, such a component or process is described, but not depicted in a drawing, the absence of such component and process from the drawings should not be considered as an omission of such design from the specification.

Before describing the present invention in detail, it should be observed that the present invention utilizes a combination of components or processes, which constitutes a system for secure payment transactions using direct processor communication. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items. Further, the word “user” and “person” are used interchangeably in the description.

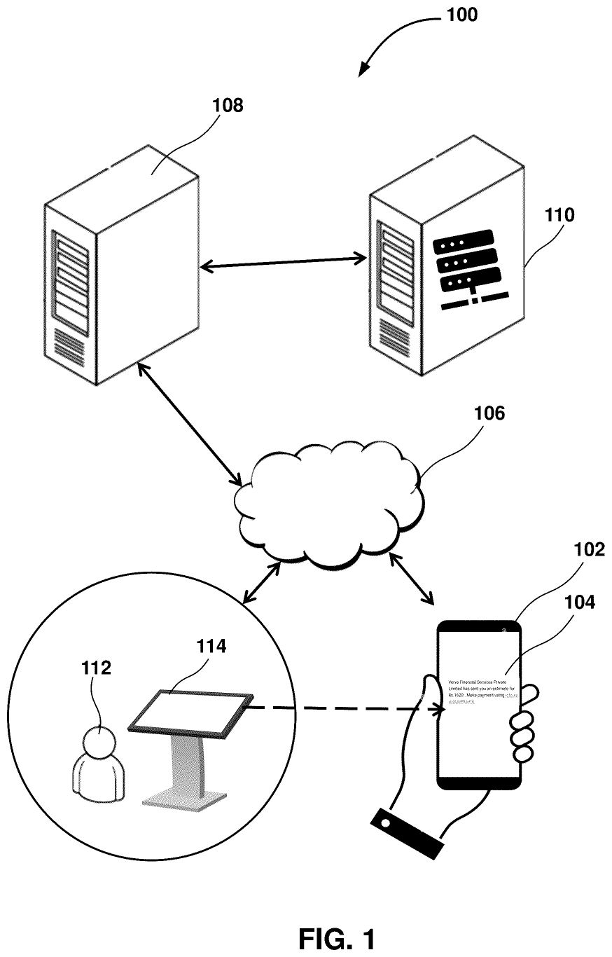

A system for secure payment transactions using direct processor communication will now be described with reference to the accompanying drawings, particularly FIGS. 1-7.

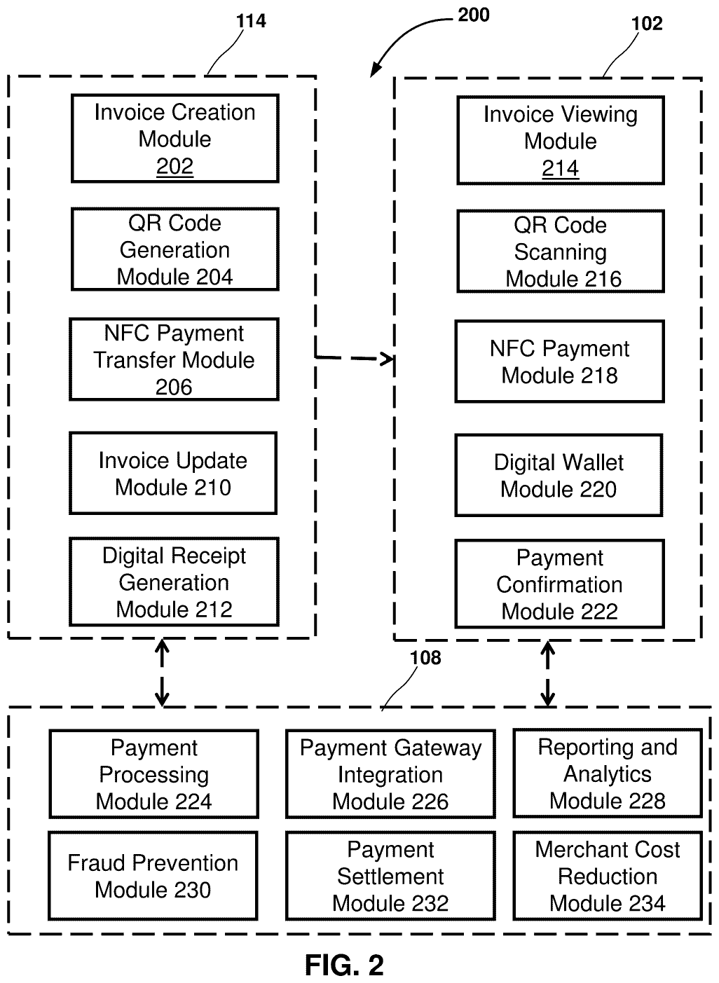

Referring to FIG. 1 in conjunction with FIGS. 2-7, illustrates a system 100 for secure payment transactions using direct processor communication, in accordance with various exemplary embodiments of the present invention. As can be seen in FIG. 1, the system includes a consumer (not shown) who purchases something at a merchant site. In an embodiment, the merchant site is a physical store. At the store, the consumer makes a decision and selects the product they want to buy. They proceed to the checkout counter with their chosen items. At the checkout, the consumer hands the items to a cashier, who scans them to calculate the total cost. When the total cost for the purchase is calculated, a payment facilitating application provided by a payment provider 108 creates a payment invoice 104 and send it to the consumer communication device 102. In an example, the payment invoice 104 is in the form of a short message service (SMS). In another example, the payment invoice is in the form of an email. In an embodiment, the consumer communication device 102 may be configured to include payment vouchers, such as mobile carrier provider minutes or mobile carrier provider data, and bank-generated digital vouchers equivalent to a demand draft. These vouchers essentially represent a form of monetary possession or items that can be exchanged for money and are accepted by merchant banks. Such vouchers may be utilized with offline merchant 114 and offline consumer communication device 102.

In an embodiment, the payment invoice 104 is sent to a consumer in real-time through either scanning a payment invoice code or tapping the consumer's communication device 102 to transfer the invoice data. Further, the payment is processed by the consumer using a payment application or manually entering card details on the consumer's communication device 102, without transmitting secret card details to the merchant 112. Further, the payment provider 108 receives the transaction details from the consumer and verifies the transaction with a financial institution, for example, bank 110. Upon verification. the merchant payment invoice is updated. Different sub-modules which are responsible for completion of the above process are disclosed in conjunction with FIG. 2.

In another embodiment, the consumer initiates the purchase using their device, such as a smartphone or computer, to select items and proceed to checkout. The merchant 112 is the business or individual selling the product or service. The merchant's role is to provide the product details, pricing, and checkout options on their website or app. The merchant device 112 is used by the merchant to manage the transaction. It could be a point-of-sale (POS) system, or an online payment gateway integrated into their website. Upon the consumer confirming their purchase, the payment invoice 104 is generated. This payment invoice 104 includes details of the transaction, such as the amount, merchant information, payment link, and invoice number. The transaction data is securely transmitted over a communication network 106, such as the internet, connecting the consumer device 102. merchant device 114, payment provider 108, and bank 110.

In the context of the present invention, the consumer's communication device 102 refers to an electronic device that can be used to communicate over the communication network 108. Examples of the communication device include but are not limited to a cell phone, a smartphone, a cellular phone, a cellular mobile phone, a personal digital assistant (PDA), a personal computer, a server, a cloud-enabled device, a laptop, and a tablet computer. Examples of types of the communication network include but are not limited to a local area network, a wide area network, a radio network, a virtual private network, an internet area network, a metropolitan area network, a satellite network, Wi-Fi, Bluetooth Low energy, a wireless network, and a telecommunication network. Examples of the telecommunication network include but are not limited to a global system for mobile communication (GSM) network, a general packet radio service (GPRS) network, third Generation Partnership Project (3GPP), 4G, 5G, Long-Term Evolution (LTE), an enhanced data GSM environment (EDGE) and a Universal Mobile Telecommunications System (UMTS).

The payment provider 108, also known as a payment processor or gateway receives the transaction details from the merchant device 114. The payment provider 108 is responsible for forwarding the payment request to the appropriate financial institutions and ensuring the security and integrity of the transaction. To ensure the security and integrity of the transaction, the payment provider may use encryption protocols and compliance frameworks such as PCI DSS (Payment Card Industry Data Security Standard). The bank 110, typically the issuer of the consumer's payment method (e.g., credit or debit card), receives the payment authorization request from the payment provider 108. The bank 110 verifies the transaction details, checks for sufficient funds or credit, and then either approves or declines the transaction. The bank 110 ensures that the payment details match the cardholder's records. Using security measures like One-Time Passwords (OTPs) or fraud detection algorithms to identify suspicious activities. If approved, the bank notifies the payment provider (108) that the payment can proceed. Once the bank 110 approves the transaction, the payment provider 108 informs both the merchant 112 and the consumer of the successful payment. The merchant 112 can then proceed with fulfilling the order, and the consumer receives a confirmation of their purchase. After receiving the confirmation, the merchant updates their systems to reflect that payment has been received. For online purchases, this could mean moving the order into “shipping” status, and for in-store purchases, it allows the customer to leave with their items.

Consider an example scenario, John Doe is at a coffee shop and wants to pay for his purchase using a secure payment method that doesn't share his card details with the merchant. The coffee shop enters his order into the merchant's point-of-sale system, which is integrated with software provided by a payment provider (e.g., Pay™, Stripe). The system generates a payment invoice for the total amount of his purchase. The merchant's system displays a QR code on the screen. John Doe scans this QR code using his smartphone, or alternatively, the merchant taps their device with his phone to transfer the invoice data via NFC (Near Field Communication). On his smartphone, he opens his payment application (e.g., Google Pay. Apple Pay, Pay™). The application automatically retrieves the invoice details. He confirms the payment within the app, which processes the transaction directly with his bank or payment provider. In this scenario his card details are never shared with the merchant; they remain secure within the payment app and the payment processor's system. Once the payment is confirmed, the payment provider's system sends a notification back to the merchant's point-of-sale system. The merchant's invoice is automatically updated to reflect the completed payment transaction.

Consider another example scenario, a customer orders a product online and chooses to pay using digital vouchers that they've accumulated from their mobile carrier. After placing the order, they receive an invoice via SMS or email. The consumer can redeem their mobile minutes or data as payment through the same system. In this scenario, the transaction happens offline or online without involving credit card details.

In yet another scenario, John Doe visits an offline utility payment kiosk in a mall to pay his electricity bill. The system sends an invoice to his phone via NFC tapping or scanning a QR code at the kiosk. John uses his stored bank vouchers equivalent to demand drafts for this transaction. The payment process is completed without the utility company gaining access to his bank details.

In yet another scenario, a consumer places an order in a coffee shop and taps their phone on the NFC-enabled terminal. The payment invoice is transferred directly to their smartphone, and they complete the payment using their digital wallet. The system updates the transaction status in real-time, confirming both to the consumer and the merchant that the payment was successful, without ever transmitting sensitive card information.

FIG. 2 illustrates a schematic diagram of various sub-modules of the system for secure payment transactions, according to an embodiment of the present invention. As shown in FIG. 2, the consumer's communication device 102 includes invoice viewing module 214, QR code scanning module 216, NFC payment module 218, Digital wallet module 220, and Payment confirmation module 222. Further, the merchant device 114 includes Invoice creation module 202, QR code generation module 204, NFC payment transfer module 206, Invoice update module 210, and Digital receipt generation module 212. Furthermore, the payment provider 108 includes Payment processing module 224, Payment gateway integration module 226, Reporting and analytics module 228, Fraud prevention module 230, Payment settlement module 232, and Merchant cost reduction module 234.

In an embodiment, the Invoice Creation Module 202 dynamically generates the payment invoice 104 based on the specific items the consumer selects for purchase. The invoice creation module 202 calculates the total amount the consumer owes, taking into account the prices of the items, applicable taxes, and discounts, and prepares all necessary details for the invoice. Once the invoice is created, the Invoice Viewing Module 214 ensures that the consumer has full visibility of the transaction. The Invoice Viewing Module 214 allows the consumer to view the payment invoice 104 sent to their device in a user-friendly format. The Invoice Viewing Module 214 displays the details of the transaction, including items purchased, total cost, and various payment options (e.g., payment link). In an embodiment, the various options might include links to payment gateways, allowing the consumer to make payments via digital wallets or credit cards. Further, the QR Code Generation Module 204 creates QR codes that correspond to the payment invoice. These QR codes allow consumers to easily access their invoices by scanning the QR code with their mobile devices, whether at the merchant's checkout counter or from a digital receipt. In the above context, QR codes are used as an example, the system is flexible to support other types of codes or technologies, ensuring that the core functionality of secure, efficient transactions remains intact. The QR Code Scanning Module 216 enables the consumer's device to scan QR codes, which can be used to quickly access payment invoices or payment portals by simply scanning the code presented at the merchant's checkout. By scanning the QR code. the consumer can instantly view their invoice or be directed to a payment portal, allowing them to complete the transaction without manually entering any details. This creates a smooth, secure, and convenient payment process, eliminating the need for handling sensitive card information directly.

The NFC Payment Transfer Module 206 facilitates the transfer of payment information via NFC technology when the consumer taps their device on the merchant's payment terminal. This “tap-to-pay” functionality enables quick, contactless transactions, reducing the need for physical card swiping. The NFC Payment Transfer Module 206 ensures that payment data, such as encrypted card details or tokenized information, is securely transferred to the payment provider 108. The NFC Payment Module 218 resides within the consumer's device allows the consumer to make contactless payments by tapping their device near an NFC-enabled payment terminal. When a consumer taps their device near the NFC-enabled terminal, the NFC Payment Module 218 handles the communication between the consumer's communication device and the merchant terminal, ensuring that the payment details are properly exchanged. It uses encrypted protocols to ensure that sensitive card information is never exposed or compromised during the transaction. Further, the Digital Wallet Module 220 acts as a virtual wallet, stores digital versions of payment cards and other financial instruments, allowing the consumer to select and use these stored payment methods for transactions. Additionally, the Digital Wallet 220 may be equipped to store digital currency such as cryptocurrencies. The Digital Wallet Module 220 facilitates the use of stored payment information without needing to physically present a card, enhancing both security and convenience for the user. If merchant 114 transmits a complete invoice to device 104 via NFC or another future communication method that supports enhanced data transfer, the communication device 104 can subsequently transmit digital currency to merchant 114. The transaction is executed entirely through the consumer's device, keeping the payment process secure and seamless. Once the payment is initiated, the Payment Processing Module 224 handles the actual processing of payments, communicating with financial institutions to authorize and complete transactions. The Payment Processing Module 224 ensures that the consumer has sufficient funds or credit to complete the transaction. Furthermore, the Payment Gateway Integration Module 226 integrates with various payment gateways (such as Stripe, PayPal, or local bank gateways), allowing the system to process payments through different financial networks and services. By integrating with multiple gateways, the system ensures compatibility with a wide range of payment networks and financial institutions, allowing for flexibility in how payments are processed. This ensures that the payment is routed through the appropriate network based on the consumer's payment method and the merchant's banking infrastructure.

After the payment is processed whether via digital wallet, credit card, or another payment method, the Payment Confirmation Module 222 confirms the transaction to the consumer, providing a receipt or confirmation message. The confirmation message can take the form of a notification, such as a text message, an email, or an in-app alert, assuring the consumer that the payment has been completed. After a payment is made, the Invoice Update Module 210 updates the invoice to reflect the completed transaction, ensuring the merchant's records are accurate and up to date. For example, the Invoice Update Module 210 updates the status of the invoice in the merchant's system, marking it as paid. This feature eliminates the need for manual reconciliation, ensuring real-time accuracy in the merchant's accounts. It helps in keeping a clear and organized record of all transactions, preventing errors that could result from manual tracking and ensuring that the merchant's backend system reflects up-to-date payment statuses. Further, the Digital Receipt Generation Module 212 creates a digital receipt for the transaction, which can be sent to the consumer's communication device or printed as needed. The receipt contains details of the purchase, including items bought, total amount, payment method, and any applicable taxes or discounts. The receipt can be sent to the consumer's communication device, such as their smartphone or email, allowing for easy access and storage. Alternatively, the receipt can be printed if needed, particularly in physical stores where consumers might still prefer a paper copy. This module simplifies record-keeping for consumers and merchants alike, providing a seamless and convenient way to handle post-purchase documentation.

Further, the Reporting and Analytics Module 228 provides detailed reports and analytics on transactions, helping merchants and payment providers track sales, identify trends, and manage finances. By analysing transaction data, it helps track sales patterns, consumer behaviour, and financial performance. For example, a merchant can view reports on peak sales times, average transaction values, and customer purchasing trends. These analytics enable merchants to make informed business decisions, such as optimizing inventory management or tailoring marketing campaigns. Additionally, payment providers can leverage this data to improve service offerings, identify areas for improvement, and offer value-added services to their clients. The Fraud Prevention Module 230 monitors transactions for suspicious activity and implements measures to prevent fraudulent transactions, ensuring the security of the payment process. In an embodiment, the Fraud Prevention Module 230 monitors transactions in real-time for signs of suspicious activity, such as unusual transaction amounts, location mismatches, or multiple payment attempts. It uses algorithms and predefined rules to flag potential fraudulent transactions and takes measures to prevent fraud, such as requiring additional verification (e.g., OTPs) or halting the transaction altogether.

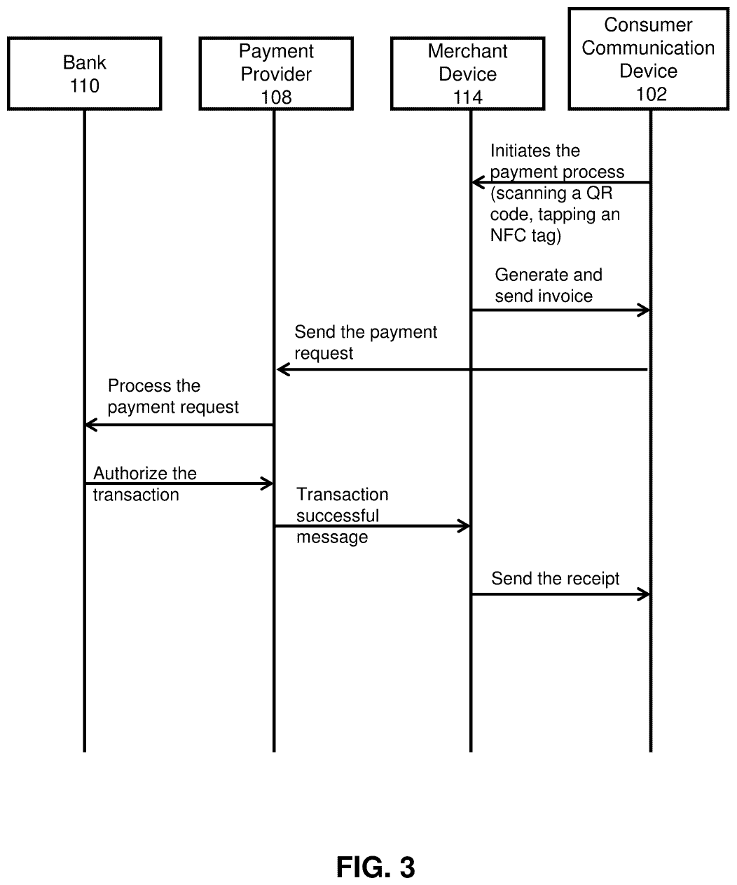

Once a transaction is authorized and completed, the Payment Settlement Module 232 handles the settlement of funds, ensuring that payments are correctly transferred from the consumer's account to the merchant's account. Payment Settlement Module 232 handles any complexities involved in fund settlements, such as reconciling payments across different financial institutions or managing multi-currency transactions. It ensures that all parties involved in the transaction are settled promptly and accurately, minimizing any delays or errors in the payment process. The Merchant Cost Reduction Module 234 aims to reduce transaction costs for merchants by optimizing payment processing and leveraging cost-saving techniques and technologies. In an embodiment, the Merchant Cost Reduction Module 234 may prioritize processing transactions through channels that offer lower fees or negotiate better rates with payment providers. By reducing operational costs, this module helps merchants increase their profit margins while providing a seamless payment experience for customers. All the above modules rely on seamless communication between the consumer's communication device (102), the merchant's device (114), and the payment provider (108). Communication between different devices, for example, the consumer's communication device 102, the merchant device 114, and the payment provider 108 is disclosed in conjunction with FIG. 3.

The various actions, acts, blocks, steps, or the like in the schematic diagram may be performed in the order presented, in a different order, or simultaneously. Further, in some embodiments, some of the actions, acts, blocks, steps, or the like may be omitted, added, modified, skipped, or the like without departing from the scope of the invention.

FIG. 3 is a sequence diagram illustrating communication between different devices, (e.g., the consumer's communication device 102, the merchant device 114, and the payment provider 108) for secure payment transactions, according to an embodiment of the present invention. As shown in FIG. 3, The consumer initiates the payment process on their communication device 102. This FIG. 3 could involve scanning a QR code, tapping an NFC tag, or entering payment details. The merchant device 114 generates an invoice and sends it to the consumer's device 102. This invoice may include transaction details such as the amount and merchant information. The consumer's device 102 sends a payment request to the payment provider 108. This request includes the payment details and the transaction amount.

The payment provider 108 processes the payment request. This involves verifying the payment details, checking for sufficient funds, and ensuring the transaction's security. The payment provider 108 communicates with the financial institution (e.g., a bank) to authorize the transaction. The financial institution verifies the details and confirms whether the transaction should proceed. Once authorized, the payment provider 108 sends a confirmation message back to the consumer's device 102 and the merchant device 114. This confirms that the transaction was successful. The merchant device 114 may generate a digital receipt and send it to the consumer's device 102. This receipt serves as proof of the transaction. The transaction is completed, and both the consumer and the merchant have records of the transaction.

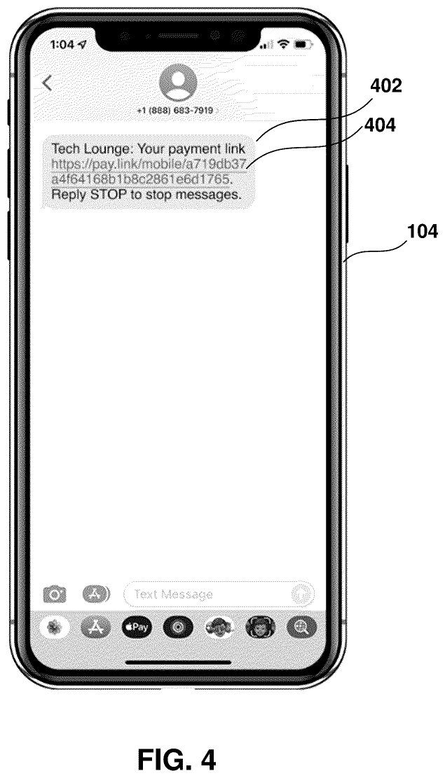

FIG. 4 is an example snapshot illustrating the payment invoice 104 received by the consumer, according to an embodiment of the present invention. As shown in FIG. 4, the payment invoice 104 includes a hyperlink to the payment gateway. The Payment Invoice 104 is the document or digital representation that details the amount the consumer needs to pay. It typically includes information such as the total amount due, the merchant's details, and a breakdown of charges. The hyperlink 404 provides a direct and convenient way for the consumer to initiate the payment process. By clicking on this link, the consumer is redirected to a web page or application where they can enter their payment details, such as credit card information or other payment methods. The payment gateway link 404 is typically encrypted to ensure that all data transmitted between the consumer's device and the payment processor is secure. This helps in protecting sensitive information from unauthorized access and fraud. Including a hyperlink in the invoice simplifies the payment process for the consumer, reducing the need to manually enter payment details or visit a separate payment portal. This streamlined approach enhances user convenience and can lead to faster payment processing.

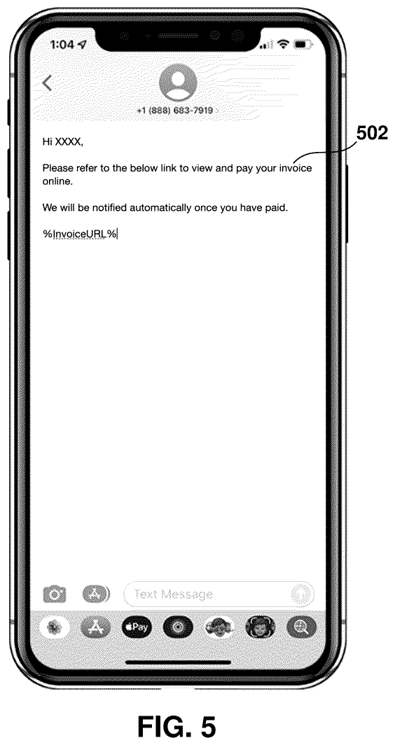

FIG. 5 is an example snapshot illustrating an updated payment invoice 502 received by the consumer, according to an embodiment of the present invention. The Updated Payment Invoice is the revised document or digital representation sent to the consumer after any changes have been made to the initial invoice. It reflects updated information such as corrected charges, adjusted amounts, or added details that were not present in the original invoice. The updated invoice includes detailed information about the consumer, such as name, address, and contact details, ensuring that the invoice is personalized and correctly addressed. The merchant's name, address, and contact information are also clearly displayed, providing transparency and contact points for any queries. Dates indicating when the invoice was issued and when the payment is due, help the consumer manage their payment timelines. Any additional notes, terms, or conditions related to the payment or transaction, ensure that the consumer is fully informed.

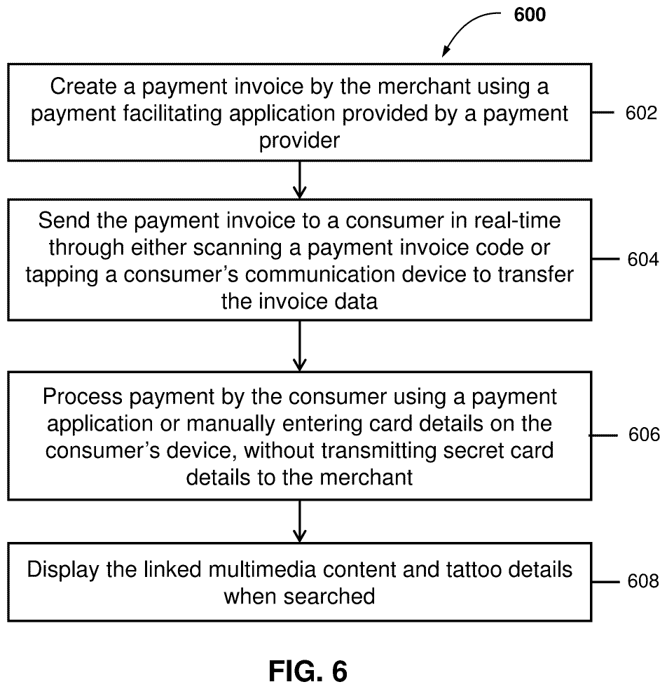

FIG. 6 illustrates a flow diagram of a method for secure payment transactions using direct processor communication, according to an embodiment of the present invention. At step 602, the method includes creating the payment invoice 104 by the merchant 112 using the payment facilitating application provided by the payment provider 108. The method allows the Invoice creation module 202 to create the payment invoice 104 by the merchant 112 using the payment facilitating application provided by the payment provider 108.

At step 604, the method includes sending the payment invoice to the consumer in real-time through either scanning the payment invoice code or tapping the consumer's communication device 102 to transfer the invoice data. The method allows the QR Code Generation Module 204 and NFC Payment Transfer Module 206 to send the payment invoice to the consumer in real time. At step 606, the method includes processing the payment by the consumer using the payment application or manually entering card details on the consumer's communication device 102, without transmitting secret card details to the merchant. The method allows the Payment Processing Module 224 to process the payment.

At step 608, the method includes updating the merchant payment invoice automatically upon completion of the payment transaction. The method allows the Invoice Update Module 210 to update the merchant payment invoice automatically upon completion of the payment transaction.

The various actions, acts, blocks, steps, or the like in the flow diagram may be performed in the order presented, in a different order, or simultaneously. Further, in some embodiments, some of the actions, acts, blocks, steps, or the like may be omitted, added, modified, skipped, or the like without departing from the scope of the invention.

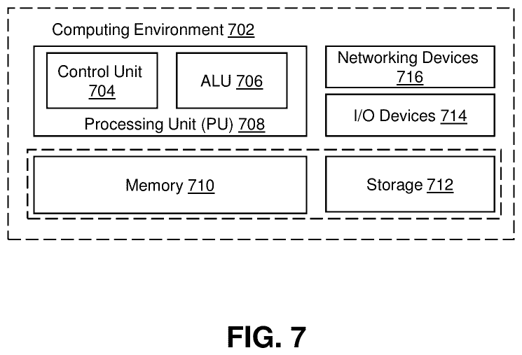

Referring to FIG. 7 illustrates a computing environment of the consumer electronic device 102 conducting the payment transaction at the merchant site 114 without sharing secret card details with the merchant 112, according to embodiments disclosed herein. As depicted in the figure, the computing environment 702 comprises at least one processing unit 708 that is equipped with a control unit 704 and an Arithmetic Logic Unit (ALU) 706, a memory 710, a storage unit 712, plurality of networking devices 716 and a plurality of input output (I/O) devices 714.

The processing unit 708 is responsible for processing the instructions of the technique. The processing unit 708 receives commands from the control unit in order to perform its processing. Further, any logical and arithmetic operations involved in the execution of the instructions are computed with the help of the ALU 706. The overall computing environment 702 can be composed of multiple homogeneous and/or heterogeneous cores, multiple CPUs of different kinds, special media and other accelerators.

The processing unit 708 is responsible for processing the instructions of the technique. Further, the plurality of processing units 708 may be located on a single chip or over multiple chips. The technique comprising of instructions and codes required for the implementation are stored in either the memory unit 710 or the storage 712 or both. At the time of execution, the instructions may be fetched from the corresponding memory 710 or storage 712 and executed by the processing unit 708. In case of any hardware implementations, various networking devices 716 or external I/O devices 714 may be connected to the computing environment to support the implementation through the networking unit and the I/O device unit.

The embodiments disclosed herein can be implemented through at least one software program running on at least one hardware device and performing network management functions to control the elements. The elements shown in the FIGS. 1 through 7 include user interfaces, blocks which can be at least one of a hardware device, software routines, or a combination of hardware device and software units. The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

One of the primary advantages of the described method for conducting payment transactions without sharing secret card details with the merchant is enhanced security. By utilizing a system where the payment invoice is created and sent to the consumer in real-time, and the payment is processed by the consumer's device, sensitive card information is never transmitted to the merchant. This significantly reduces the risk of data breaches and fraud, as merchants do not have access to or store sensitive card details. Additionally, consumers can feel more confident in the security of their transactions, knowing that their card information remains private and is handled directly by secure payment providers.

Another advantage of this method is the potential for cost savings for merchants. Since the process eliminates the need for merchants to handle card details directly, it reduces the necessity for maintaining expensive card reader devices and the associated security measures. The method also reduces transaction fees, as lower fraud risks can lead to decreased insurance costs from the merchant's bank. Furthermore, the automation of payment status updates and digital receipt integration streamlines the transaction process, improving efficiency and reducing administrative burdens. These cost savings and operational efficiencies can result in better financial outcomes for merchants while providing a seamless and secure payment experience for consumers.

Although particular embodiments of the invention have been described in detail for purposes of illustration, various modifications and enhancements may be made without departing from the spirit and scope of the invention.

What is claimed is:

1. A method for conducting a payment transaction at a merchant site, comprising:
creating a payment invoice by a merchant using a payment facilitating application provided by a payment provider;
sending the payment invoice to a consumer in real-time by scanning a payment invoice code or tapping a consumer's communication device to transfer the invoice data;
processing a payment by the consumer using a payment application or by manually entering card details on the consumer's communication device, wherein sensitive card details are retained secure and undisclosed to the merchant; and
automatically updating the merchant payment invoice on completion of the payment transaction.

2. The method of claim 1, wherein the payment invoice is sent to the consumer via a QR code that can be scanned using the consumer's communication device.

3. The method of claim 1, wherein the payment invoice is sent to the consumer through a URL link transmitted by NFC.

4. The method of claim 1, wherein the consumer uses a digital wallet application to process the payment.

5. The method of claim 1, wherein the consumer manually enters the card information on their communication devices to complete the payment transaction.

6. The method of claim 1 further comprising automatically updating the merchant's payment status upon receipt of payment confirmation from a payment processor.

7. The method of claim 1, wherein the consumer receives a digital receipt on their communication devices after completing the payment.

8. The method of claim 1, wherein the digital receipt is automatically integrated into a consumer's invoice management application.

9. The method of claim 1 further comprising verifying the payment transaction with the financial institution.

10. The method of claim 9, wherein the verification process is initiated directly by the payment provider to the financial institution without merchant involvement.

11. A system for secure payment transactions using direct processor communication, comprising:
a merchant device configured to create and send a payment invoice to a consumer;
a consumer device configured to receive the payment invoice and process the payment using a payment application;
a payment processor configured to verify the transaction with a financial institution; and
an update module configured to update the payment status on the merchant's system upon transaction completion.

12. The system of claim 11, wherein the merchant device includes a QR code generation module for creating a QR code representing the payment invoice.

13. The system of claim 11, wherein the merchant device includes an NFC payment transfer module for transmitting the payment invoice via NFC.

14. The system of claim 11, wherein the consumer device includes a QR code scanning module for retrieving the payment invoice by scanning.

15. The system of claim 11, wherein the consumer device includes an NFC payment module for receiving the payment invoice via NFC.

16. The system of claim 11, wherein the consumer device includes a digital wallet module for storing and using digital payment methods.

17. The system of claim 11, wherein the payment processor includes a fraud prevention module for monitoring and preventing fraudulent transactions.

18. The system of claim 11, wherein the payment processor includes a payment processing module for handling the transaction.

19. The system of claim 11, wherein the payment processor includes a payment settlement module to ensure accurate transfer of funds from the consumer to the merchant.

20. The system of claim 11, wherein the merchant device includes a digital receipt generation module for creating and sending a digital receipt to the consumer's device.

21. A computer program product for conducting secure payment transactions using direct processor communication, the computer program comprising:
a set of instructions executable by a merchant device to generate a payment invoice based on transaction details, and transmit said invoice to a consumer's communication device via a secure protocol;
a set of instructions executable by a consumer's device to receive the payment invoice, decode the invoice data, and process the payment using a payment application configured to prevent the transmission of sensitive card details to the merchant;
a set of instructions executable by a payment provider's server to receive and verify the payment transaction by communicating with a financial institution and performing multi-factor authentication for transaction validation; and
a set of instructions executable by a transaction update module on the merchant's device to receive confirmation of payment completion from the payment provider and automatically update the payment status in the merchant's system.
